(19) United States
(12) Patent Application Publication
(10) Pub. No.: US 2010/0019509 A1
(43) Pub. Date: Jan. 28, 2010

(54) FASTENER

(76) Inventor: Chad Allen Perrott, Woodstock, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/179,561

(22) Filed: Jul. 24, 2008

(51) Int. Cl. E05C 19/10; B65D 85/00

(52) U.S. Cl. 292/102; 292/107; 206/524.1

(57) ABSTRACT

One exemplary embodiment can be a fastener. The fastener can include a body. Generally, the body, in turn, includes a first end, a second end, and a protrusion. Usually, each end is adapted to engage a respective catch, where the at least a portion of the ends are generally aligned in a first plane, and at least a portion of the protrusion is not aligned with the first plane for engaging yet another catch.

### FIELD OF THE INVENTION

This invention generally relates to a fastener, which may be particularly suited to secure a cover in a vessel.

### DESCRIPTION OF THE RELATED ART

Processing vessels can be employed in a variety of industries, such as food, pharmaceutical, chemical, refinery, or petrochemical processing. Generally, such vessels can include reactors, distillation columns, and absorbers. Often, such vessels can have external man-ways for allowing access to the internal components. Moreover, often such vessels also include internal man-ways for accessing various structures within the vessel.

Generally, the internal man-ways can be situated on a tray for accessing, for example, one or more catalyst beds located below the trays. Typically, a tray forms a hole creating the man-way, which can be covered by a plate or cover. Typically, the cover is secured with several nuts and bolts around its periphery.

Unfortunately, using nuts and bolts can present several disadvantages. The nuts attached to the bolts can be subject to excessive torque. Excessive torque can result in rounding off the nuts and/or stripping the bolt threads rendering the combination useless. Moreover, galling can occur due to hydrocarbon processing which, optionally in conjunction with excessive torque, may result in certain points of the nuts and bolts becoming welded together. If excessive galling occurs, the nut may not unscrew from the bolt.

Due to these problems, the cutting of a bolt may be required for removing the combination and opening the man-way cover. However, this solution can create unnecessary delays. In addition, often the man-way cover is difficult to access due to other equipment inside of the vessel. Consequently, this can further exasperate the difficulty of cutting and removing the bolts to open the cover.

Several solutions have been attempted to overcome such deficiencies, such as utilizing different metals for the nut and bolt to prevent galling. Regrettably, even if such metals are successful in preventing galling, there is still the risk of excessive torque despite extensive time and training provided to operation personnel to prevent such occurrences. Consequently, there is a desire for improved fasteners that overcome these shortcomings.

### SUMMARY OF THE INVENTION

One exemplary embodiment can be a fastener. The fastener can include a body. Generally, the body, in turn, includes a first end, a second end, and a protrusion. Usually, each end is adapted to engage a respective catch, where the at least a portion of the ends are generally aligned in a first plane, and at least a portion of the protrusion is not aligned with the first plane for engaging yet another catch.

Another exemplary embodiment may be an internal structure for a vessel. Generally, the internal structure includes a first member at least partially bordering a man-way, a second member covering the man-way, and a fastener. Generally, the fastener includes a body. The body can include a first end and a second end. Additionally, the fastener can include a first catch coupled to the second member and adapted to engage the first end, and a second catch coupled to the first member and adapted to engage the second end.

Yet another embodiment can be a vessel. Generally, the vessel includes an enclosure defining an interior volume and at least one internal structure. The at least one internal structure, in turn, can include a first member at least partially bordering an opening, a second member covering the opening, and a fastener. Generally, the fastener has a body. The body can include a first end and a second end. In addition, the fastener may include a first catch coupled to the second member and adapted to releasably engage the first end, and a second catch coupled to the first member and adapted to releasably engage the second end.

The fastener as disclosed herein can provide a suitable mechanism for securing a man-way cover within a vessel without the use of bolts and nuts, which have the deficiencies as described above. As such, the embodiment disclosed herein will facilitate the removal of such man-way covers during a downtime for, e.g., maintenance or equipment refurbishing, generally without the use of tools, such as wrenches. Particularly, during downtimes it is usually advantageous to proceed quickly due to the desire to restart the unit.

### DEFINITIONS

As used herein, the term “coupled” can mean two items, directly or indirectly, joined, fastened, associated, connected, or formed integrally together either by chemical or mechanical means, by processes including stamping, molding, or welding. What is more, two items can be coupled by the use of a third component such as a mechanical fastener, e.g. a screw, a nail, a staple, or a rivet; an adhesive; or a solder.

As used herein, the terms “substantially” and “considerably” can be used interchangeably and have the same meaning.

As used herein, the term “covering” can mean partially or entirely covering an opening, such as a man-way.

### BRIEF DESCRIPTION OF THE DRAWINGS

FIG. 1 is a partial, cross-sectional schematic depiction of a portion of an exemplary vessel.

FIG. 2 is a top, plan view along line 2-2 of FIG. 1 of an exemplary tray and cover.

FIG. 3 is a perspective view of an exemplary fastener.

FIG. 4 is an elevational, side view of the exemplary fastener.

FIG. 5 is a top, plan view of the exemplary fastener.

FIG. 6 is a perspective view of another exemplary fastener.

FIG. 7 is a side, elevational view of the another exemplary fastener.

FIG. 8 is a top, plan view of the another exemplary fastener.

### DETAILED DESCRIPTION

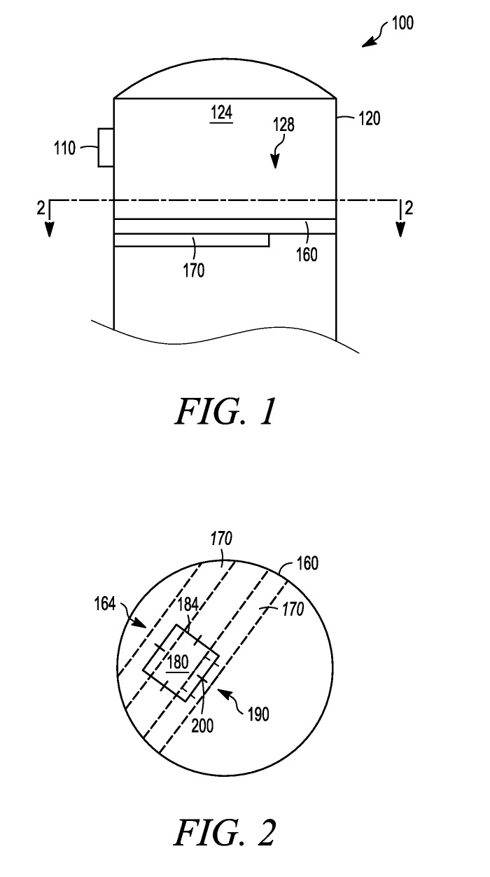

Referring to FIGS. 1-2, a portion of an exemplary vessel 100 is depicted. The vessel 100 can be any type of processing vessel, such as a reactor, a distillation column, an absorber, or a stripper. Generally, such a vessel 100 can facilitate mass transfer operations in any flow orientation, such as downflow, upflow, co-current flow, and counter-current flow for one or more fluids, such as a gas, a liquid, or a mixed-phase of liquid and gas. Often, the vessel 100 can include one or more vapor and/or liquid mixing, contacting, collecting, and/or redistributing trays.

In this exemplary embodiment, the vessel 100 can include an external man-way 110 allowing access to an enclosure 120 defining an interior volume 124 and containing at least one internal structure 128. In this exemplary embodiment, the vessel 100 can be a reactor 100 having the internal structure 128, namely a first member 160, such as a tray 160, above, for example, a packed bed of catalyst. Although one tray 160 is depicted, it should be understood that any number of trays may be included. The tray 160 can include other structures, such as bubble caps, tray valves, downcomers, and weirs to facilitate desired operations. The external man-way 110 can be any suitable shape, and typically can be circular, hexagonal, or octagonal. Generally, the external man-way 110 can be secured with a cover that is attached by a series of bolts and nuts around its perimeter. Removing the bolts and nuts can allow access to the interior volume 124.

Referring to FIG. 2, the tray 160 can form an opening 164, which is typically a man-way 164. Although in this preferred embodiment the tray 160 surrounds the man-way 164, it should be understood that the man-way 164 can be at least partially formed by the wall of the vessel 100 or other structure, and have its shape at least partially defined thereby. As a result, the tray 160 can at least partially or completely border the man-way 164. The man-way 164 can be covered by a second member 180, which is typically a man-way cover 180. Generally, the man-way 164 can be any suitable shape, such as a hexagon, a circle, a parallelogram, a rhombus, or other polygon shape. The man-way cover 180 can have a shape corresponding to that of the man-way 164. As such, the man-way cover 180 can also be any corresponding suitable shape, such as a hexagon, a circle, a parallelogram, a rhombus, or other polygon shape. Generally, the man-way cover 180 can rest on one or more supports or beams 170 (depicted in phantom) underneath the tray 160. The man-way cover 180 can include a perimeter 184. About the perimeter 184, a plurality of fasteners 190, including a fastener 200, can be provided to secure the man-way cover 180 during, e.g., hydrocarbon processing. Although four fasteners 190 are depicted, it should be understood that any number of fasteners 190 may be used to secure the man-way cover 180 to the tray 160. Also, it should be understood that the man-way cover 180 can be secured to other structures inside the vessel 100 other than the tray 160, such as the one or more supports 170.

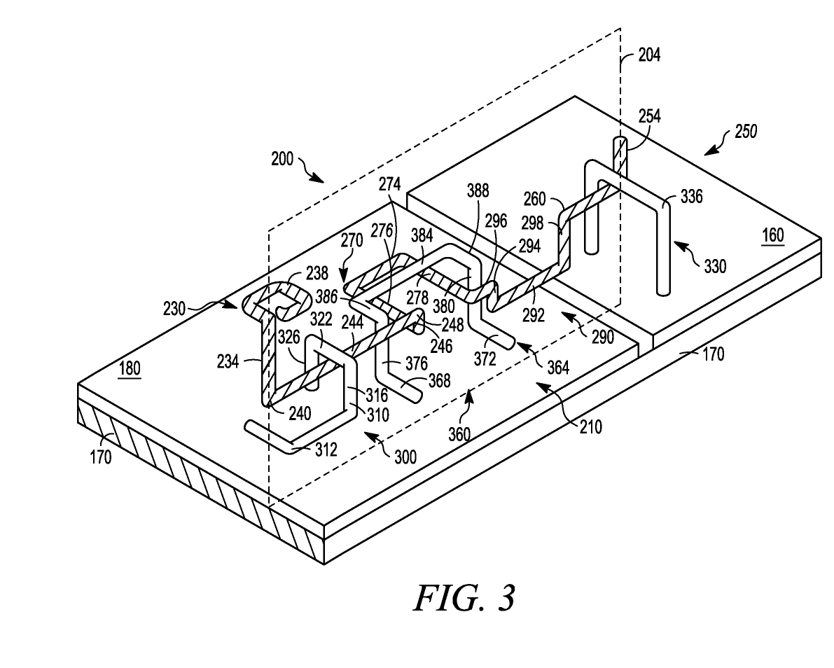

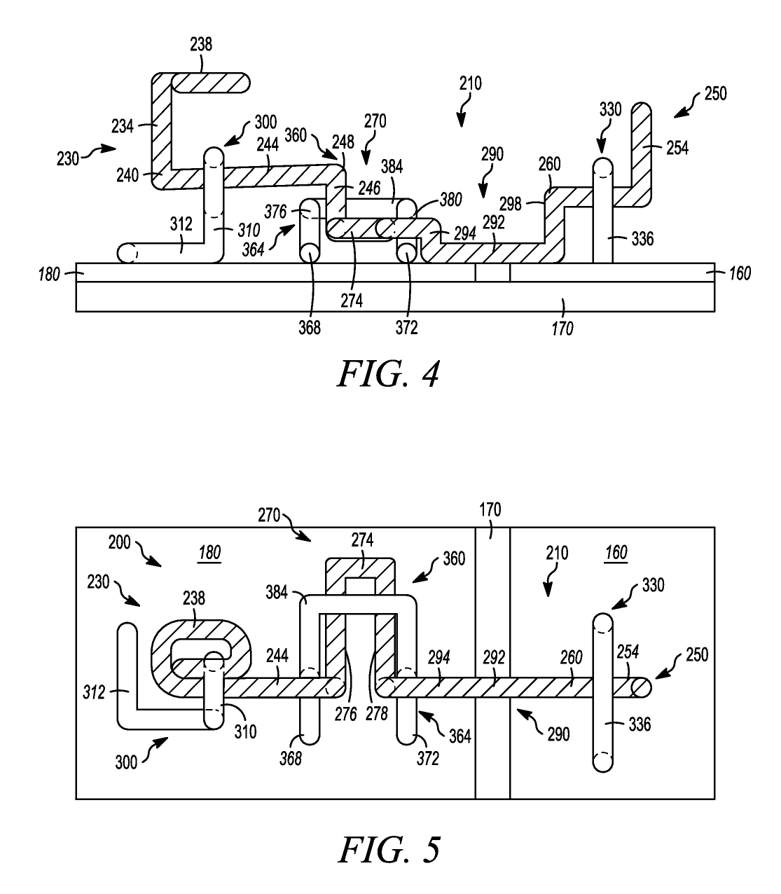

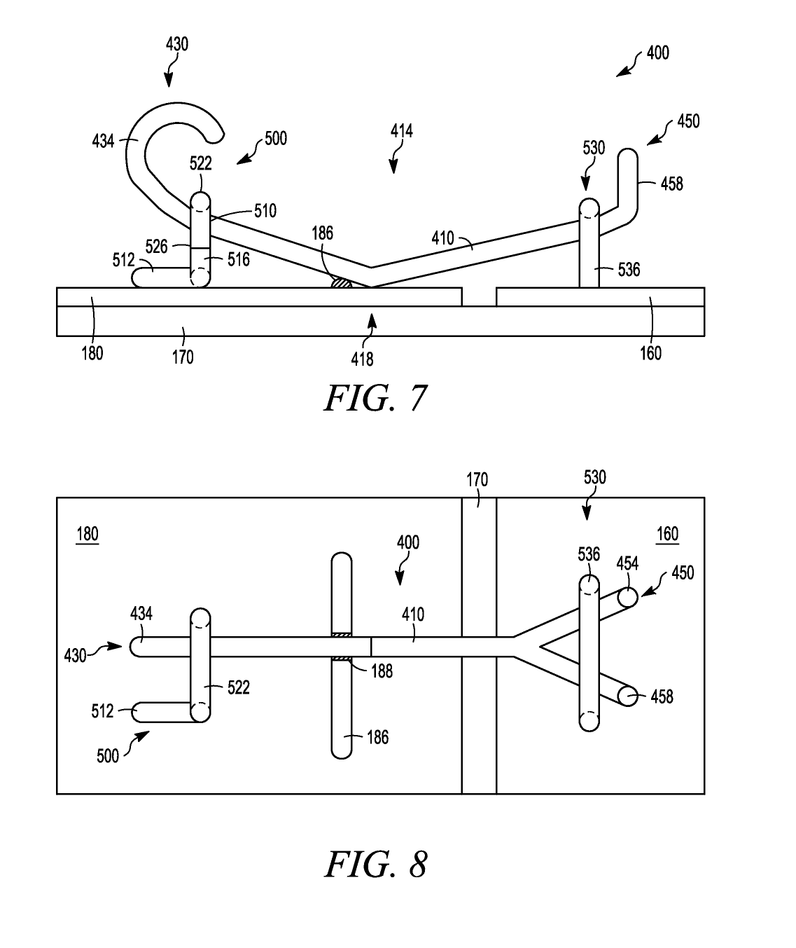

As depicted in FIG. 2, a rectangular section is depicted around the fastener 200 with dashed lines. This cut-away section is depicted in more detail in FIGS. 3-8 and is used for illustrative purposes only.

Referring to FIGS. 3-5, one exemplary fastener 200 of the plurality of fasteners 190 is depicted. The fastener 200 can include a body 210, a first catch 300, a second catch 330, and a third catch 360. Generally, each catch 300, 330, and 360 can protrude above the tray 160 and/or the man-way cover 180. The body 210 is depicted in cross-hatching for illustrative purposes only for distinguishing it from the catches 300, 330, and 360. Generally, the body 210 has a three-dimensional zig-zag shape or a key-shape that includes one or more hooks and/or protrusions for engaging the one or more catches 300, 330, and 360 for securing the man-way cover 180. Typically, the body 210 has a first end 230, a second end 250, a protrusion 270, and a base 290, and can function as a “key” when removed from the catches 300, 330, and 360 to unsecure the man-way 180.

Generally, at least a portion, typically the entire, first end 230 and the second end 250 can lie generally in a, typically substantially vertical, first plane 204. Usually, the first end 230 can form a first hook 234 terminating in a handle 238 at one end and forming a resilient shoulder 240 coupled to, preferably formed integrally with, a considerably horizontal run 244 extending from the resilient shoulder 240. The horizontal run 244, in turn, can be coupled, preferably integrally formed with, a substantially vertically descending leg 246 at an elbow 248 of about 90°, as viewed from the side. The horizontal run 244 can be tensioned at the elbow 248, namely pressing upwards against the catch 300. At the other end of the body 210, the second end 250 can form a second hook 254 at one end and a resilient second shoulder 260 at the other.

The protrusion 270 generally has at least a portion 274 extending substantially perpendicular from the first plane 204, and in this preferred embodiment, the at least a portion 274 is generally horizontal. Thus, the at least a portion 274 is not aligned with the first plane 204. Preferably, the at least a portion 274 is tensioned when securing the man-way cover 180, namely pressing upwards against the third catch 360. Typically, the protrusion 270 is a loop. Preferably, the protrusion 270 forms a horizontally orientated, side-ways jack arch with a first leg 276 and a second leg 278. Generally, ajack arch is an arch with no rise, i.e., the crown is generally at the same elevation as the springers.

The base 290 can have at least a portion 292 abutting one or more surfaces, such as a surface of the tray 160 and/or the man-way cover 180. The base 290 can further include a first arm 294 and a second arm 298 at either end of the at least one portion 292. Generally, the first and second arms 294 and 298 are substantially vertical. Usually, the first arm 294 can be coupled to, preferably formed integrally with, a substantially horizontal connector 296 at an angle of about 90°, as viewed from the side.

Generally, the first end 230, the second end 250, the protrusion 270, and the base 290 are formed integrally together, but each part may be coupled to an adjoining part in any suitable manner. Typically, the descending leg 246 of the first end 230 is formed integrally with the first leg 276 of the protrusion 270 at an angle of about 90°, as viewed from an end 230 or 250. Additionally, the second leg 278 of the protrusion 270 can be formed integrally with the substantially horizontal connector 296 of the base 290 at an angle of about 90°, as viewed from above. Furthermore, the second arm 298 of the base 290 can be formed integrally with the resilient second shoulder 260 of the second end 250 at an angle of about 90°, as viewed from the side.

Moreover, the fastener 200 can further include a first catch 300, a second catch 330, and a third catch 360, adapted to releasably engage the body 210 of the fastener 200. Generally, the first catch 300, the second catch 330, and the third catch 360 are coupled to the first member 160 and the man-way cover 180 using any simple means, such as welding.

The first catch 300 can include a gate 310 for securing the first end 230 of the fastener 200. The gate 310 can include a substantially horizontal L-shaped leg 312 formed integrally with a considerably vertical member 316. The considerably vertical member 316 can further be formed integrally with a substantially horizontal member 322, which in turn may be formed integrally with a descending arm 326. The descending arm 326 can extend downward substantially perpendicular to the substantially horizontal member 322, yet terminate before contacting the man-way cover 180. Particularly, the descending arm 326 can terminate to leave a gap for removing the first end 230, as hereinafter described.

The second catch 330 can be any suitable shape, and generally can take the form of a loop. In this exemplary embodiment, the second catch 330 can be the form of ajack arch 336 to secure the second end 250 of the body 210. The second catch 330 attached to the man-way cover 160 can also serve as a handgrip to facilitate its removal once the body 210 is removed from the catches 300, 330, and 360.

The third catch 360 can include a base 364 that may include a first member 368 and a second member 372. The first and second member 368 and 372 can be in a general parallel relationship to one another. A first leg 376 can be orientated substantially vertically and coupled to the first member 368, and a second leg 380 can be orientated substantially vertically coupled to the second member 372. Each leg 376 and 380 can be substantially parallel to each other. At the terminal ends of the legs 376 and 380, a substantially horizontal loop 384 can be coupled to each leg 376 and 380. Particularly, the loop 384 can include a first end 386 and a second end 388. Generally, the first end 386 can be coupled to an end of the first leg 376, and the second end 388 can be coupled to an end of the second leg 380.

In operation, the body 210 of the fastener 200 can be secured by the first catch 300, the second catch 330, and the third catch 360. To remove the body 210, the first end 230 can be lowered out-from-under the horizontal member 322 and the descending arm 326 of the first catch 300. Removing the first end 230 can be accomplished by pushing downward on the handle 238 which flexes at the elbow 248. Afterwards, the protrusion 270 can be removed from the third catch 360. Afterwards, the fastener 200 can be rotated to remove the second hook 254 from the second catch 330. Removing similar fasteners 190 can allow removal of the man-way cover 180 from the man-way 164.

To secure the man-way cover 180, the second hook 254 of the second end 250 can be positioned under the jack arch 336 of the second catch 330. Next, pivoting the body 210 can position the protrusion 270 of the body 210 within the loop 384 of the third catch 360, and abut at least a portion 292 of the base 290 on the tray 160 and the man-way cover 180. The protrusion 270 can be tensioned against the loop 384. That being done, the first end 230 can be positioned under the gate 310 of the first catch 300. Flexing the body 210 can move the first end 230 over the substantially horizontal member 322 and under the descending arm 326. The first end 230 can flex at the elbow 248 and the resilient first shoulder 240. As a consequence, the horizontal run 244 of the first end 230 of the body 210 can be positioned under and tensioned against the substantially horizontal member 322 of the first catch 300.

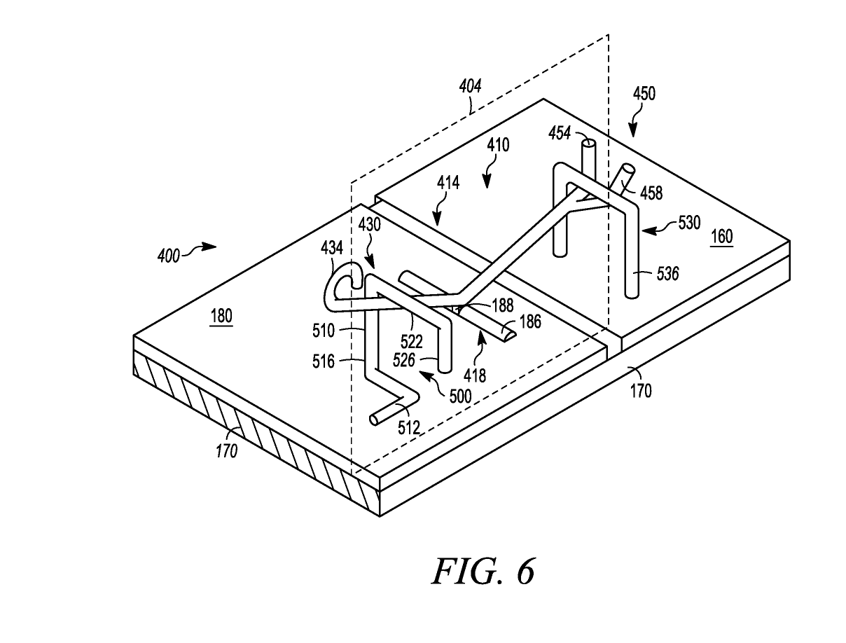

Referring to FIGS. 6-8, another exemplary fastener 400 is depicted, which can be used instead of the fastener 200 described above. The fastener 400 can have a body 410 forming an angle 414, preferably an obtuse angle creating a base 418; a first end 430 forming a handle 434; and a second end 450 forming a first branch 454 and a second branch 458. Generally, the branches 454 and 458 can form a “Y” with the body 410 at the second end 450. Thus, the first and second branches 454 and 458 can collectively form a hook. Although two branches 454 and 458 are depicted, it should be understood any number of branches, such as one branch or three or more branches may be included. Also, the branches 454 and 458 can form a single piece located equi-distance between the branches 454 and 458. At least a portion of the first end 430 and/or the second end 450 can lie in the same general, typically vertical, plane 404. The body 410 of the fastener 400 can act as a key to secure the man-way cover 180, similarly to the body 210 of the fastener 200 as described above.

In addition, the fastener 400 can include a first catch 500 and a second catch 530. The first catch 500 can be similar to the first catch 300 described above. Preferably, the first catch 500 may include a gate 510, in turn, having an L-shaped leg 512, a substantially vertical member 516, and a substantially horizontal member 522, which in turn may be formed integrally with a descending arm 526. The descending arm 526 can extend downward substantially perpendicular to the substantially horizontal member 522, yet terminate before contacting the man-way cover 180. Particularly, the descending arm 526 can terminate above the tray 180 to leave a gap for removing the first end 430, as hereinafter described.

The second catch 530 can be substantially similar as the catch 330 described above, and can include a jack arch 536. In addition, the man-way cover 180 can form a ridge 186 forming a groove 188. The groove 188 can receive the base 418 of the body 410 for securing it.

In operation, the handle 434 of the first end 430 can be slid out from underneath the substantially horizontal member 522 of the first catch 500. Similarly, the base 418 of the body 410 can be pivoted out from the groove 188 of the ridge 186. Subsequently, the first and second branches 454 and 458 can be slid under and out from the jack arch 536 of the second catch 530. Removing similar fasteners 190 can allow removal of the man-way cover 180 from the man-way 164. Reversing these steps can reinsert the fastener 400 to secure the tray cover 180.

The fasteners 200 and 400, can be fashioned from any suitable material, and one preferred material is a metal or a metal alloy. The material can be titanium, carbon steel, or stainless steel. Particularly, suitable stainless steels can be AISI designations 304, 316, 347, or 410 stainless steel, alloy 20 with AISI designation A555-79, and a stainless steel alloy sold under the trade name Monel by Inco Alloys International, Inc. of Huntington, W. Va. Typically, the fasteners 200 and 400 can be fashioned from such a material in the form of a wire, and the wire can have a diameter of about 0.6-about 2 cm. Fashioning the fasteners 200 and 400 from these materials will permit the construction of a fastener having sufficient resilience to allow its flexing around the various catches for securing the man-way cover 180.

Although individual catches have been described as either secured to the tray 160 or the man-way cover 180, it should be understood that catches can be fastened to either the tray 160 or the man-way cover 180, and the body of the fastener orientated accordingly. As an example, the catches 300 and 360 can be coupled to the tray 160, the catch 330 can be coupled to the man-way cover 180, and the body 210 can be orientated accordingly for the fastener 200. In some preferred embodiments, the catch 330 can be sufficiently sturdy to serve as a handhold for removing the man-way cover 180.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A fastener, comprising:
1) a body comprising:
a) a first end;
b) a second end; and
c) a protrusion;
wherein each end is adapted to engage a respective catch; at least a portion of the ends are generally aligned in a first plane; and at least a portion of the protrusion is not aligned with the first plane for engaging yet another catch.

2. The fastener according to claim 1, wherein the first and second ends form respective first and second hooks.

3. The fastener according to claim 1, wherein the body further comprises a base having at least a portion adapted for abutting a surface.

4. The fastener according to claim 2, further comprising a resilient first shoulder coupling the first hook to the protrusion, and a resilient second shoulder coupling the second hook to the base.

5. The fastener according to claim 2, wherein the base further comprises resilient first and second arms, wherein the first and second arms couple, respectively, the protrusion and the second shoulder.

6. The fastener according to claim 3, wherein the first and second hooks are formed integrally with, respectively, the protrusion and the base.

7. An internal structure for a vessel, comprising:
A) a first member at least partially bordering a man-way;
B) a second member covering the man-way; and
C) a fastener, wherein the fastener comprises:
1) a body comprising:
a) a first end; and
b) a second end;
2) a first catch coupled to the second member and adapted to engage the first end; and
3) a second catch coupled to the first member and adapted to engage the second end.

8. The internal structure according to claim 7, wherein the body forms an angle to provide a base.

9. The internal structure according to claim 7, wherein the second end splits into two branches.

10. The internal structure according to claim 7, wherein the first end forms a handle.

11. The internal structure according to claim 8, wherein the second member forms a ridge, in turn, forming a groove, to receive the base of the fastener.

12. The internal structure according to claim 7, further comprising a plurality of fasteners.

13. The internal structure according to claim 7, wherein at least a portion of the first and second ends of the body are generally aligned in a first plane, and the body forms a protrusion not aligned with the first plane for engaging a third catch.

14. The internal structure according to claim 13, wherein the third catch is coupled to the second member.

15. The internal structure according to claim 7, wherein the first member comprises a tray and the second member comprises a man-way cover.

16. The internal structure according to claim 15, wherein the man-way cover has a perimeter shaped as a hexagon, a circle, a parallelogram, a rhombus, or other polygon shape.

17. The internal structure according to claim 13, wherein:
the first catch forms a gate comprising a substantially vertical member coupled to a substantially horizontal member;
the second catch forms a jack arch; and
the third catch comprises:
a base comprising a first member and a second member;
a first leg and a second leg coupled to the base wherein each leg is orientated substantially vertically; and
a loop orientated substantially horizontally and comprising first and second ends wherein each end of the loop is coupled to, respectively, the first leg and the second leg.

18. A vessel, comprising:
I) an enclosure defining an interior volume;
II) at least one internal structure comprising:
A) a first member at least partially bordering an opening;
B) a second member covering the opening; and
C) a fastener, wherein the fastener comprises:
1) a body comprising:
a) a first end; and
b) a second end;
2) a first catch coupled to the second member and adapted to releasably engage the first end; and
3) a second catch coupled to the first member and adapted to releasably engage the second end.

19. The vessel according to claim 18, wherein each catch protrudes above the first and/or second members.

20. The vessel according to claim 18, wherein the fastener comprises stainless steel, carbon steel, or titanium, and has a diameter of about 0.6-about 2.0 cm.
